(19) United States
(12) Patent Application Publication
(10) Pub. No.: US 2008/0192742 A1
(43) Pub. Date: Aug. 14, 2008

(54) Communication Control Apparatus, Receiver Apparatus, Integrated Circuit, and Communication Control Method

(75) Inventors: Yuki Kobayashi, Osaka (JP); Kentaro Saito, Osaka (JP); Taku Matsuda, Nara (JP); Kenji Shioyama, Kyoto (JP)

Correspondence Address: WENDEROTH, LIND & PONACK L.L.P., 2033 K. STREET, NW, SUITE 800, WASHINGTON, DC, 20006, US

(73) Assignee: MATSUSHITA ELECTRIC INDUSTRIAL CO., LTD., Osaka (JP)

(21) Appl. No.: 11/915,956

(22) PCT Filed: Jul. 18, 2006
(86) PCT No.: PCT/JP2006/314180

§ 371 Date: Nov. 29, 2007

(30) Foreign Application Priority Data
Jul. 20, 2005 (JP) 2005-209529

(51) Int. Cl. H04L 12/56

(52) U.S. Cl. 370/389

(57) ABSTRACT

A communication control apparatus (101) receiving packets transmitted via a network (1) includes a packet classifying unit (112) which classifies the received packets into either a first type packet including streaming data streaming-delivered or a second type packet not including the streaming data, based on protocol identifier information and a port number included in each of the received packets, and a bus I/F (113) which transfers the streaming data to a first memory area assigned to a main memory (104) and the second type packet to a second memory area assigned to the main memory (104), the second memory area being different from the first memory area.

### TECHNICAL FIELD

The present invention relates to a communication control apparatus, and particularly to the communication control apparatus which classifies received packets into either a packet including streaming data or a packet not including the streaming data.

### BACKGROUND ART

In recent years, a streaming delivery of contents (e.g., audio, video, and the like) via a network has actively taken place. Ensuring continuity and real-timeness of data in such streaming delivery requires that received packets be processed at high-speed. Nonetheless, since it is assumed that a conventional network controller and the like are used in a computer system, a central processing unit (CPU) and an external circuit which convert a signal format and correct delay, other than the network controller, are required. Moreover, regarding a video signal, just like other data, as the received packets are processed by the CPU, a load is put on the CPU. In response, a technique for processing the received packets at high-speed without putting the load on the CPU has been proposed (e.g., refer to Patent Reference 1).

For example, as shown by FIG. 1, a communication control apparatus 11 of a communication apparatus 10 receives a packet 20 transmitted from a network 1 and analyzes the received packet 20. After the analysis, a payload (data 21) of the packet 20 is moved via a bus 13 to a user space by a Direct Memory Access (DMA) transfer, and a header is moved via the bus 13 to an operating system (OS) space by the DMA transfer.

The term “user space” refers to a memory area assigned to a main memory 14 when executing the OS, and also a memory area used when executing an application. The term “OS space” refers to a memory area assigned to the main memory 14 when executing the OS, and also a memory area used when executing a kernel of the OS.

At this time, based on added information provided at a source in transmission, or more specifically divided information 22 and receiving area designating information 23, the communication control apparatus 11 transfers the data 21 to any two or more areas belonging to the user space assigned to the main memory 14. That is to say, part of data which is to be transferred to applications is directly transferred to a data memory area of each application.

Here, the communication control apparatus 11 knows a DMA transfer address from a table associated with the added information.

Patent Reference 1: Japanese Unexamined Patent Application Publication No. 2004-94931.

### DISCLOSURE OF INVENTION

### Problems that Invention is to Solve

However, in the above-mentioned conventional technique, although a received packet provided with added information can be processed at high-speed, nothing is different from the conventional technique in terms of a received packet not provided with added information. In other words, in the case where special information such as the added information cannot be embedded in a packet at a source, nothing is different from the conventional technique. That is to say, there is a problem that whether or not received packets can be processed at high-speed without putting a load on a CPU depends on the source.

Consequently, the present invention is brought about in view of the above-mentioned problem, and has an object of providing a communication control apparatus which does not necessarily depend on the source to process the received packets at high-speed without putting the load on the CPU.

### Means to Solve the Problems

In order to achieve the above object, a communication control apparatus according to the present invention is (a) a communication control apparatus receiving packets transmitted via a network, and includes (b) a classifying unit which classifies the received packets into either a first type packet including streaming data streaming-delivered or a second type packet not including the streaming data, based on protocol identifier information and a port number included in each of the received packets, and (c) a transfer unit which transfers the streaming data to a first memory area assigned to a main memory and the second type packet to a second memory area assigned to the main memory, the second memory area being different from the first memory area.

For this reason, although special information such as added information and the like is not embedded in a packet at a source, the received packets can be classified into either a packet including streaming data or a packet not including the streaming data based on protocol identifier information and a port number. Moreover, the streaming data and the packet not including the streaming data can be individually transferred to a memory. As a result, a process of extracting the streaming data from the packet including the streaming data can be omitted in a CPU. That is to say, the received packets can be processed at high-speed without putting a load on the CPU.

Furthermore, (a) the transfer unit may include: (a1) a first buffer into which the streaming data is stored; (a2) a second buffer into which the second type packet is stored; and (a3) a memory access controller which prioritizes transferring the streaming data stored in the first buffer to the first memory area over transferring the second type packet stored in the second buffer to the second memory area, and (b) the classifying unit may allow the streaming data included in the packet classified as the first type packet to be stored in the first buffer, and the packet classified as the second type packet to be stored in the second buffer.

This way, ensuring real-timeness and continuity in processing the streaming data becomes easier.

In addition, (a) the transfer unit may include: (a1) a start address register which holds a start address of the first memory area; (a2) an end address register which holds an end address of the first memory area; (a3) a write address register which holds a writing start address of the streaming data to be stored in the first memory area; and (a4) a read address register which holds a reading start address of the streaming data stored in the first memory area, and (b) the memory access controller may write the streaming data stored in the first buffer in sequence from the writing start address to the reading start address, and write from the start address again when writing reaches the end address.

For this reason, although all the streaming data are not stored, storing only an amount necessary for processing the streaming data can help suppress an amount of memory consumption.

It should be noted that the present invention may be realized not only as a communication control apparatus but also as a receiver apparatus provided with the communication control apparatus, a method for controlling the communication control apparatus, and an integrated circuit.

### EFFECTS OF THE INVENTION

According to a communication control apparatus of the present invention, although special information such as added information and the like is not embedded in a packet at a source, received packets can be classified into either a packet including streaming data or a packet not including the streaming data based on protocol identifier information and a port number. In addition, the streaming data and the packet not including the streaming data can be individually transferred to a memory. As a result, a process of extracting the streaming data from the packet including the streaming data can be omitted in a CPU. That is to say, the received packet can be processed at high-speed without putting a load on the CPU.

### BRIEF DESCRIPTION OF DRAWINGS

FIG. 1 is a view showing a configuration of a communication apparatus which includes a communication control apparatus according to a conventional technique.

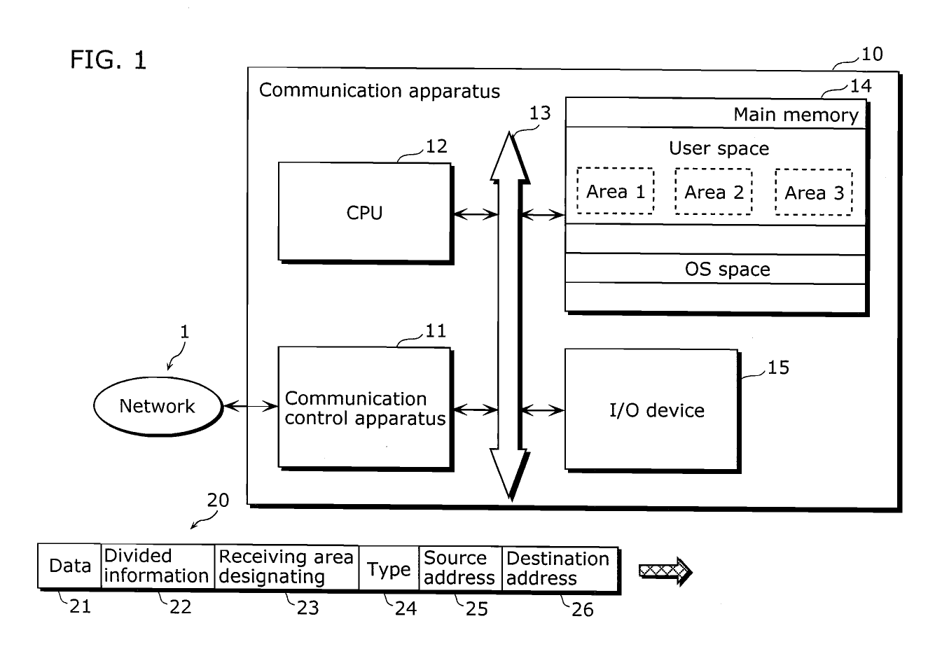

FIG. 2 is a view showing a configuration of a receiver apparatus which includes a communication control apparatus according to an embodiment of the present invention.

FIG. 3 is a view showing a frame format of a memory area assigned to a main memory according to the embodiment of the present invention.

FIG. 4 is a view showing a detailed configuration of a bus I/F according to the embodiment of the present invention.

FIG. 5 is a flowchart showing a packet classifying process performed by a packet classifying unit according to the embodiment of the present invention.

### NUMERICAL REFERENCES

1 Network
10 Communication apparatus
11, 101 Communication control apparatus
12, 102 CPU
13, 103 Bus
14, 104 Main memory
15 I/O device
100 Receiver apparatus
105 Decoder
111 Transmitting and receiving I/F
112 Packet classifying unit
113 Bus I/F

### BEST MODE FOR CARRYING OUT THE INVENTION

(Embodiment) The following describes an embodiment according to the present invention with reference to the drawings.

A communication control apparatus according to the present embodiment is (a) the communication control apparatus receiving packets transmitted via a network, which (b) classifies the received packets into either a first type packet including streaming data stream-ring-delivered or a second type packet not including the streaming data, based on protocol identifier information and a port number included in each of the received packets, and (c) transfers the streaming data to a first memory area assigned to a main memory and the second type packet to a second memory area assigned to the main memory, the second memory area being different from the first memory area.

On the basis of the above points, the communication control apparatus according to the embodiment of the present invention is described.

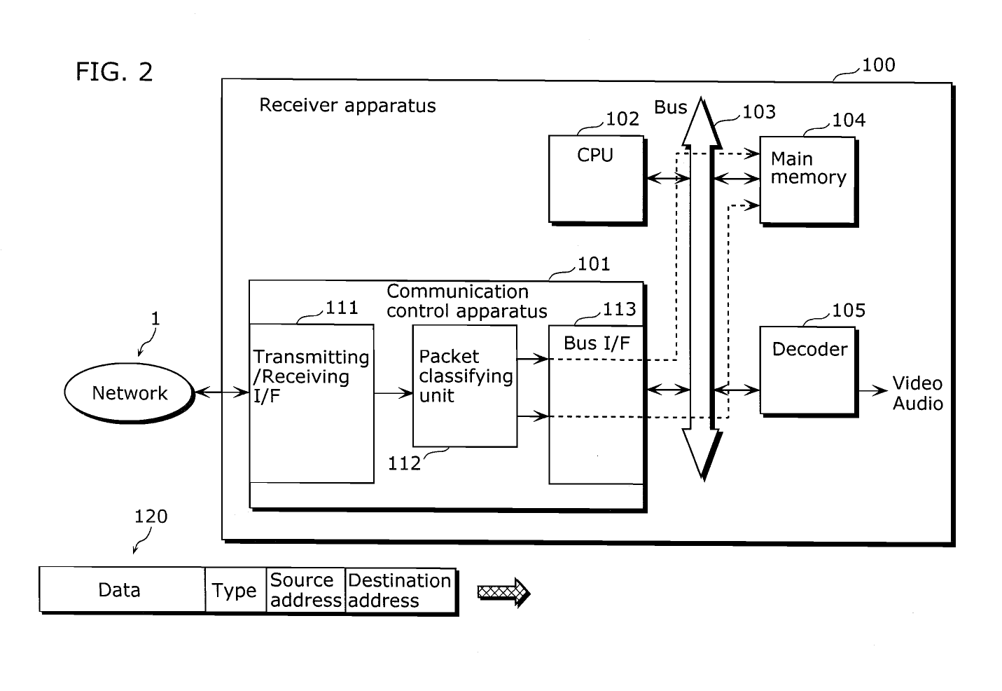

To begin with, a configuration of the communication control apparatus according to the embodiment of the present invention is described. Here, as an example shown by FIG. 2, a communication control apparatus 101 provided to a receiver apparatus 100 is described. It should be noted that the receiver apparatus 100 includes the communication control apparatus 101, a CPU 102, a main memory 104, a decoder 105, and the like. Each of them is mutually connected via a bus 103. Moreover, the communication control apparatus 101 includes a transmitting and receiving I/F 111, a packet classifying unit 112, a bus I/F 113, and the like.

The communication control apparatus 101 receives a packet 120 transmitted from a network 1 and performs a packet classifying process on the received packet 120. Then, as a result of performing the packet classifying process, payload (data) of the packet 120 is moved via the bus 103 to the main memory 104 by a DMA transfer.

The term “packet classifying process” refers to a process for classifying packets outputted from the transmitting and receiving I/F 111 into either a packet including streaming data (hereinafter called a stream packet) or a packet not including the streaming data (hereinafter called a non-stream packet). The term “streaming data” refers to data streaming-delivered. It should be noted that, as a non-stream packet, there are, for example, a packet and the like including a Web page, an e-mail, or the like. As the streaming data, there are, for example, audio data and image data that are distributed in MPEG-Transport Stream (TS) format.

At this time, at the transmitting and receiving I/F 111, the communication control apparatus 101 receives packets transmitted from the network 1 and outputs packets addressed to itself, among from the received packets, to the packet classifying unit 112. At the packet classifying unit 112, the packet classifying process is performed on a packet outputted from the transmitting and receiving I/F 111, and a non-stream packet is transferred via the bus I/F 113 to a non-stream packet memory area. Moreover, streaming data included in a stream packet is transferred via the bus I/F 113 to a streaming data memory area.

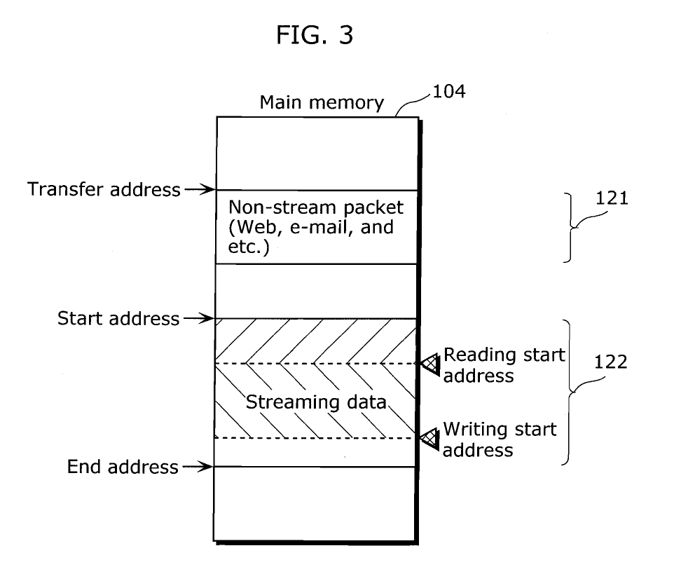

Here, as shown by FIG. 3, a non-stream packet memory area 121 is a memory area assigned to the main memory 104, the non-stream packet memory area 121 being different from a streaming data memory area 122, and a memory area managed by a transfer address pointer to which writing of the non-stream packet gets started. The streaming data memory area 122 is a memory area assigned to the main memory 104, and a memory area ranging from a start address to an end address.

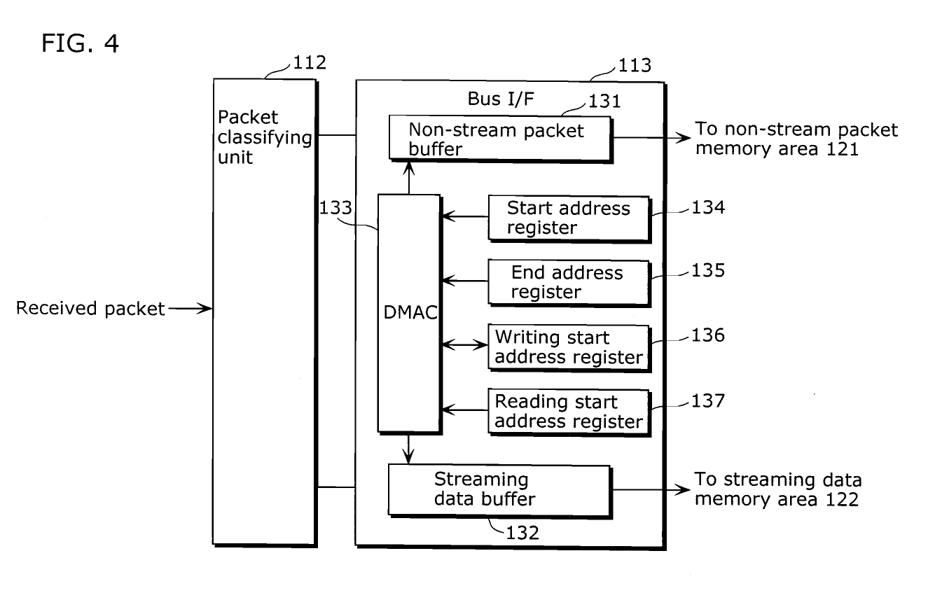

Furthermore, as shown by FIG. 4, the start address is held by a start address register 134. The end address is held by an end address register 135. A writing start address is held by a writing start address register 136. A reading start address is held by a reading start address register 137. It should be noted that the start address and the end address may be pre-set as well as set by the CPU 102.

Then, at a Direct Memory Access Controller (DMAC) 133, the bus I/F 113 transfers a non-stream packet stored in a non-stream packet buffer 131 to the non-stream packet memory area 121. In addition, streaming data stored in a streaming data buffer 132 is transferred to the streaming data memory area 122. At this time, a non-stream packet to be transferred to the non-stream packet memory area 121 is written by the DMAC 133 from a transfer address. The streaming data to be transferred to the streaming data memory area 122 is written from the writing start address. Moreover, transferring the streaming data to the streaming data memory area 122 gets priority over transferring the non-stream packet to the non-stream packet memory area 121. This way, ensuring real-timeness and continuity in processing the streaming data becomes easier.

It should be noted that every time the streaming data is transferred from the streaming data buffer 132 to the streaming data memory area 122, the writing start address is updated, within a range from the start address to the end address, to an address which is incremented by a size of the transferred streaming data. Then, when the writing start address reaches the end address by incrementing, it is updated to the start address. For this reason, although all the streaming data are not stored, storing only an amount necessary for processing the streaming data can help suppress an amount of memory consumption.

It should be noted that the transfer address is held by a transfer address register, which is not shown by the figure.

Next, an operation of the communication control apparatus according to the embodiment of the present invention is described.

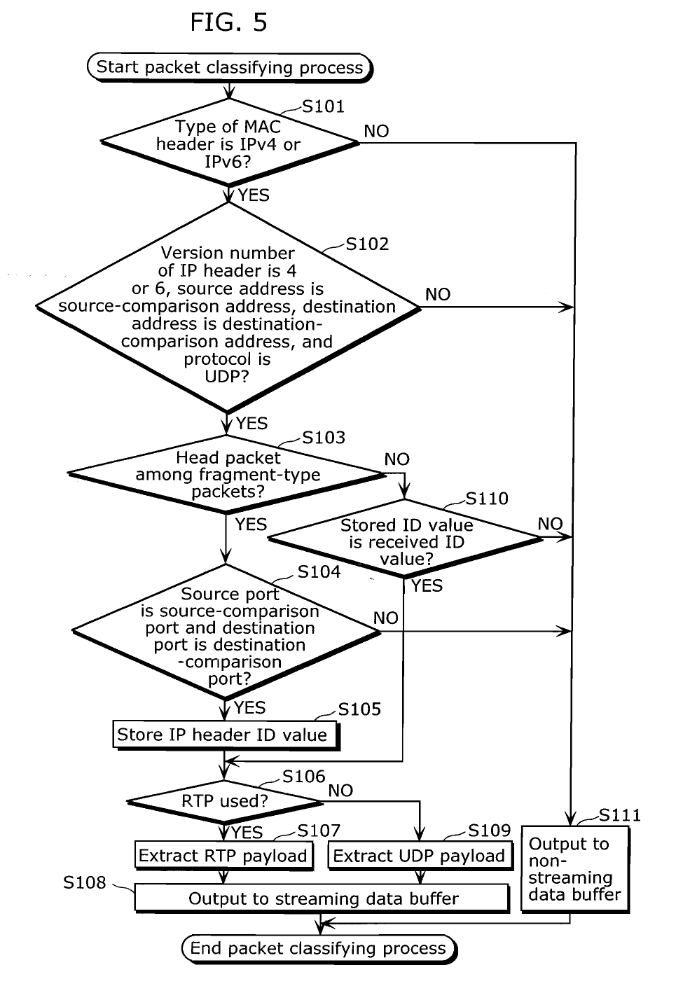

As shown by FIG. 5, in the case where conditions (1) to (4) described below are satisfied, the packet classifying unit 112 of the communication control apparatus 101 determines that a received packet outputted from the transmitting and receiving I/F 111 includes streaming data.

(1) TYPE of Media Access Control (MAC) header is IPv4 or IPv6 (Yes in S101).

(2) A version number of an Internet Protocol (IP) header included in the received packet is 4 or 6. A source address is a source-comparison address. A destination address is a destination-comparison address. A protocol is a User Datagram Protocol (UDP) (YES in S102).

(3) The received packet is the head packet among fragment-type packets (YES in S103).

(4) A source port is a source-comparison port. A destination port is a destination-comparison port (YES in S104).

That is to say, the packet classifying unit 112 classifies received packets into either a stream packet including streaming data to be streaming-delivered or non-stream packet not including the streaming data, based on protocol identifier information and a port number included in each of the received packets. At this time, the received packet is classified as the stream packet in the case where the protocol identifier information is a UDP and the port number is a number assigned to a streaming delivery service, and the received packet is classified as the non-stream packet in other cases.

It should be noted that the packet classifying unit 112 includes a source-comparison address register, a destination-comparison address register, a source port register, and a destination port register, which is not shown by the figure. The source-comparison address is held by the source-comparison address register. The destination-comparison address is held by the destination-comparison address register. The source-comparison port is held by the source-comparison port register. The destination-comparison port is held by the destination-comparison port register. Furthermore, the source-comparison address, the destination-comparison address, the source-port, and the destination port are pre-set by the CPU 102.

When it is determined that the received packet includes the streaming data (YES in S101 to S104), an ID value of an IP header included in the received packet is stored (S105). In addition, in the case where a video stream included in the received packet is transmitted based on a Real-time Transport Protocol (RTP) defined by Request For Comments (RFC) 1889, 2250, and the like (YES in S106), a RTP payload (streaming data) is extracted from the received packet (S107), and the extracted RTP payload (streaming data) is outputted to the streaming data memory area 122 (S108). It should be noted that, if not transferred based on the RTP (NO in S106), an UDP payload (streaming data) is extracted from the received packet (S109), and the extracted UDP payload (streaming data) is outputted to the streaming data memory area 122 (S108).

It should be noted that, in the case where streaming data is divided into plural packets and transferred, when the received packet is not the head packet among the fragment-type packets (NO in S103) and a stored ID value of an IP header is the ID value of the IP header (YES in S110), the packet classifying unit 112 determines that the packet also includes the video streaming. However, it is judged whether or not the video stream included in the packet is transmitted based on the RTP without updating the stored ID value of the IP header (S106).

It should be noted that, in the case where conditions (1), (2), and (4) are not satisfied, the packet classifying unit 112 determines that the packet does not include the video stream. That is to say, it is judged to be the non-stream packet other than the video stream. At this time, the packet is outputted to the non-stream packet memory area (S111). Moreover, in the case where the received packet is not the head packet among the fragment-type packets, when the stored ID value of the IP header is not the ID value of the IP header of the received packet (NO in S110), the packet is outputted to the non-stream packet memory area (S111).

It should be noted that, of a series of the processes, the packet classifying 112 can individually omit judgment conditions (1) to (8) shown below in the steps S101, S102, S104, and S110.

(1) Whether or not TYPE of a MAC header is IPv4 or IPv6.

(2) Whether or not a version number of an Internet Protocol (IP) header included in the received packet is 4 or 6.

(3) Whether or not a source address is a source-comparison address.

(4) Whether or not a destination address is a destination-comparison address.

(5) Whether or not a protocol is a User Datagram Protocol (UDP).

(6) Whether or not a stored ID value of an IP header is an ID value of an IP header of the received packet.

(7) Whether or not a source port is a source-comparison port.

(8) Whether or not a destination port is a destination-comparison port.

As described above, according to the communication control apparatus 101 in the embodiment of the present invention, although special information such as added information and the like is not embedded in a packet at a source, received packets can be classified into either a packet including streaming data or a packet not including the streaming data based on a port number. In addition, the streaming data and the packet not including the streaming data can be individually transferred to a memory. As a result, a process of extracting the streaming data from the packet including the streaming data can be omitted in a CPU. That is to say, the received packet can be processed at high-speed without putting a load on the CPU.

(Other) It should be noted that at least one of the start address, the end address, the writing start address, and the reading start address is held by the start address register 134, the end address register 135, the writing start address register 136, and the reading start address register 137, instead may be held by a memory area assigned to the main memory 104 other than the non-stream packet memory area 121 and the streaming data memory area 122.

It should be noted that the communication control apparatus may be a network adaptor based on Institute of Electrical and Electronic Engineers (IEEE) 802.3, IEEE802.11, and the like; a network controller chip that handles processing a PHY layer and a MAC layer with a single chip; and a network controller chip set that handles the PHY layer and the MAC layer individually.

In addition, the network controller chip or each chip of the network controller chip set may be realized by full-custom Large Scale Integration (LSI). It may also be realized by semi-custom LSI such as an Application Specific Integration Circuit (ASIC) and the like. Moreover, it may be realized by a programmable logic device such as a Field Programmable Gate Array (FPGA), a Complex Programmable Logic Device (CPLD), and the like. Furthermore, it may be realized as a dynamic reconfigurable device which is capable of dynamically rewriting a circuit configuration.

What is more, design data which forms, on these LSIs, one or more functions making Lip the communication control apparatus may be a program written with a hardware description language (hereinafter called a HDL program), such as Very High Speed Integrated Circuit Hardware Description Language (VHDL), Verilog-HDL, System C, and the like. It may also be a net list of gate level obtained by logically synthesizing the HDL program. In addition, it may be macro cell information obtained by adding layout information, process conditions, and the like to the net list of gate level. Moreover, it may be masked data for which size, timing, and the like are stipulated.

Alternatively, logically-synthesized, laid out, and wired design data may be stored in a serial ROM to be connected to the FPGA, so as to be transferred to the FPGA when the power is on. The design data stored in the serial ROM may be directly downloaded to the FPGA when the power is on.

Furthermore, the design data may be stored in computer-readable recording medium, such as optical recording medium (e.g. CD-ROM and the like), magnetic recording medium (e.g. a hard disk and the like), magnetooptical recording medium (e.g. MO and the like), and a semiconductor memory, so as to be read by a hardware system such as an embedded system, a computer system, and the like. The design data read by other hardware system via these recording media may be downloaded to a programmable logic device via a download cable. In addition, the design data held by the programmable logic device, the serial ROM, and the like provided in the hardware system may be directly updated via the recording media.

Alternatively, the design data may be held in the hardware system on a transmission channel, so as to be obtained by other hardware system via the transmission channel, such as a network and the like. Moreover, the design data obtained from the hardware system by other hardware system via the transmission channel may be downloaded to the programmable logic device via the download cable. The design data held by the programmable logic device, the serial ROM, and the like provided in other hardware system may also be directly updated.

### INDUSTRIAL APPLICABILITY

The present invention can be used as a communication control apparatus which classifies received packets into either a packet including streaming data or a packet not including the streaming data, and especially as a communication control apparatus, such as a network adaptor or a network controller provided in an embedded system, such as a digital TV, a digital recorder, a game console, an IP telephone and the like, that processes multimedia data, including audio, video, and the like, in real time.

1. A communication control apparatus which receives packets transmitted via a network, said apparatus comprising:
a classifying unit operable to classify the received packets into either a first type packet including streaming data streaming-delivered or a second type packet not including the streaming data, based on protocol identifier information and a port number included in each of the received packets; and
a transfer unit operable to transfer the streaming data to a first memory area assigned to a main memory and the second type packet to a second memory area assigned to the main memory, the second memory area being different from the first memory area.

2. The communication control apparatus according to claim 1,
wherein said classifying unit is operable to classify the received packets as the first type packet in the case where the protocol identifier information is a UDP and the port number is a number assigned to a streaming delivery service, and as the second type packet in other cases.

3. The communication control apparatus according to claim 2,
wherein said transfer unit includes:
a first buffer into which the streaming data is stored;
a second buffer into which the second type packet is stored; and
a memory access controller operable to prioritize transferring the streaming data stored in said first buffer to the first memory area over transferring the second type packet stored in said second buffer to the second memory area, and
said classifying unit is operable to store the streaming data included in the packet classified as the first type packet into said first buffer, and the packet classified as the second type packet into said second buffer.

4. The communication control apparatus according to claim 3,
wherein said transfer unit includes:
a start address register operable to hold a start address of the first memory area;
an end address register operable to hold an end address of the first memory area;
a write address register operable to hold a writing start address of the streaming data to be stored in the first memory area; and
a read address register operable to hold a reading start address of the streaming data stored in the first memory area, and
said memory access controller is operable to write the streaming data stored in said first buffer in sequence from the writing start address to the reading start address, and to write from the start address again when writing reaches the end address.

5. A receiver apparatus which receives packets transmitted via a network and processes the received packets, said apparatus comprising:
a communication control apparatus according to claim 1,
a main memory to which a first memory area and a second memory area are assigned,
a decoder operable to read and decode the streaming data stored in the first memory area, and
a central processing unit operable to read the second type packet stored in the second memory area and to perform a packet receiving process on the read second type packet.

6. A communication control method for receiving packets transmitted via a network, said method comprising:
a classifying step of classifying the received packets into either a first type packet including streaming data streaming-delivered or a second type packet not including the streaming data, based on protocol identifier information and a port number included in each of the received packets; and
a transferring step of transferring the streaming data to a first memory area assigned to a main memory and the second type packet to a second memory area assigned to the main memory, the second memory area being different from the first memory area.

7. An integrated circuit which receives packets transmitted via a network, said integrated circuit comprising:
a classifying unit operable to classify the received packets into either a first type packet including streaming data streaming-delivered or a second type packet not including the streaming data, based on protocol identifier information and a port number included in each of the received packets; and
a transfer unit operable to transfer the streaming data to a first memory area assigned to a main memory and the second type packet to a second memory area assigned to the main memory, the second memory area being different from the first memory area.
